(19) United States
(12) Patent Application Publication
(10) Pub. No.: US 2009/0256867 A1
(43) Pub. Date: Oct. 15, 2009

(54) Method and System for Generating Accurate Images for Display by an Image Display Device

(75) Inventor: Marques Girardelli, Clackamas, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: InFocus Corporation, Wilsonville, OR (US)

(21) Appl. No.: 12/421,936

(22) Filed: Apr. 10, 2009

Related U.S. Application Data
(60) Provisional application No. 61/043,996, filed on Apr. 10, 2008.

(51) Int. Cl. G09G 5/10; G09G 5/00

(52) U.S. Cl. 345/690; 345/204

(57) ABSTRACT

Systems, and methods, for calibrating a display device to a content source are provided. After initiating operation of the image display device, and linking it to the content source to transmit an image signal from the content source to the display device, the presence of an image coder may be detected in the image signal. In some embodiments, the image coder may be identified, and a coder level for the image coder may be determined. The display device may then be calibrated based on the coder level. The image coder may be a black level coder. Other example methods may include selecting a color gamut for use with the display device, by identifying an image signal type from the content source. Based on the image signal type, a color gamut may be selected from a store of color gamuts for the image display device to use to display images from the content source.

### CROSS-REFERENCE TO RELATED APPLICATIONS

This application claims priority from U.S. Provisional Patent Application Ser. No. 61/043,996 of Marques Girardelli, entitled “METHOD AND SYSTEMS FOR CALIBRATING AN IMAGE FOR PROJECTION,” filed Apr. 10, 2008, the disclosure of which is hereby incorporated by reference in its entirety and for all purposes.

### FIELD

The present application relates to systems, apparatus and methods for generating accurate images on a display.

### BACKGROUND

Image display devices, also referred to herein as image devices, may be used in a variety of environments. For example, information display devices, including, but not limited to televisions, monitors, and projectors may be adapted to display images, including text, graphics, video images, still images, presentations, etc. Such image devices may be found in home environments and applications, education environment and applications, business facilities, conference rooms and other meeting facilities, etc. The following is a non-exhaustive list of exemplary image devices: cathode ray tubes (CRTs), projectors, flat panel liquid crystal displays (LCDs) systems, LED systems, plasma systems, front projection systems, rear projection systems, LCD monitors, etc. Large format display devices may include, but are not limited to televisions, front-projection systems, and rear-projections systems.

The images, or content, displayed on the image display devices may be provided by a plurality of different content sources. For example, content may be provided by content sources or remote computing devices, including, but not limited to, computers, laptop computers, personal computers, storage mediums, such as memory cards, DVDs, and other memory devices, cameras, telephones, Smartphones, portable data assistants, etc. Image data from the content source may be transmitted to the display device directly or through a network. The content source may be connected, e.g. wired or wirelessly, to the image device for display of the content.

In some examples, an image may be displayed by a projector. The projector may output and image to a display surface, such as a screen. Depending on various conditions, (e.g. where the image device is located, the content source signal, the content source, the display surface itself), the image may be outputted such that the displayed image is different than the image as it appeared on the content source.

For example, different content sources may have different contrast levels and color steps. Although the projectors may be calibrated during manufacture, the calibration is not directed to a specific content source. In addition, in a user environment, and/or over time, a display device may be coupled with, and receive image signals from, a variety of content sources. Accurate color reproduction may require a user to manually calibrate black levels, and/or to manually select a color gamut in an attempt to display the image as it “appears” to the content source, in other words how the creator of the content intended the image to appear, or as it was captured. In the case of selecting a color gamut, when using an existing system, a user may typically use the maximum color gamut that the display can provide. However, using the maximum color gamut the display can provide may effectively result in no primary color correction. In addition, in some cases, such as when making a presentation, a user may have a limited time to set up, the display device. It may be difficult to also spend time to adjust the appearance of the image.

### SUMMARY

The inventors herein have recognized that the accurate reproduction of color may affect the image quality. In one example, the inventors have identified systems and methods for calibrating the image display device to accommodate and more accurately reflect black levels, and color levels, as provided by the content source.

Systems, and methods, for enabling automatic calibration of a display device to a content source are provided. After initiating operation of the image display device, and linking it to the content source to transmit an image signal from the content source to the display device, the presence of an image coder may be detected in the image signal. The image coder may be identified, and a coder level for the image coder may be determined. The display device may then be calibrated based on the coder level. Other methods may automatically select a color gamut for use with the display device, for example, by identifying an image signal type from the content source. Based on the image signal type, a color gamut may be selected from a store of color gamuts for the image display device to use to display images from the content source.

This Summary is provided to introduce a simplified form of concepts that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 is schematic representation of an example display system that includes a projection device in accordance with the present disclosure.

FIG. 2 is schematic diagram illustrating various functional components that may be included in a display device to generate accurate images in accordance with the present disclosure.

FIGS. 3 to 5 are flow charts illustrating example methods for calibrating black levels of an image display device in accordance with the present disclosure.

FIGS. 6 and 7 are flow charts illustrating example methods for selecting a color gamut for the image display device in accordance with the present disclosure.

### DETAILED DESCRIPTION

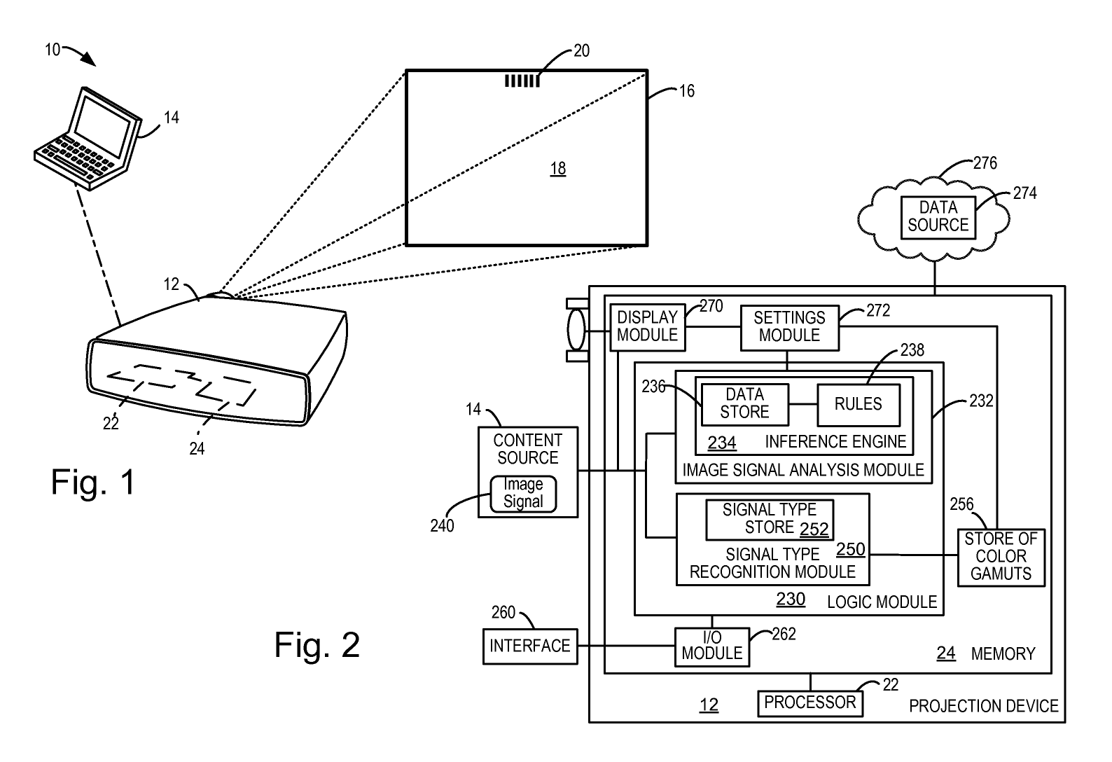

FIG. 1 is a schematic diagram illustrating an example image display system 10 in accordance with an embodiment of the present disclosure. The system 10 may include an image display device 12, a content source 14, and a display surface 16. The content source 14 may transmit content to the display device 12 such that an image 18 may be projected onto the display surface 16. Any suitable communication method may be used to transmit the image 18, including, but not limited to, wireless transmissions, wired transmission, etc. The image 18 may include one or more image coders 20. In some examples, the image coders 20 may be black level coders, such as black bars. It will be understood that the use of the terms image, or images, as used herein, may include, without limitation, still images, an/or a series of images such as streaming images, for example video streams.

As described in the Background section, image display devices may include cathode ray tubes (CRTs), projectors, flat panel liquid crystal displays (LCDs) systems, LED systems, plasma systems, front projection systems, rear projection systems, LCD monitors, etc.

The image display device 12 may include a processor 22 and a memory 24, or other storage medium. The memory 22 may be configured to hold various computer, or processor-executable instructions. The processor 22, and the memory 24, may be resident in, or may be coupled with, the projection device 12. Software may be resident in the memory 24, and may be configured to run various applications. The processor 22 may take the form of a central processing unit (CPU), or other suitable controller for controlling operation of the projection device 12. Processor 22 may be configured to manage operation, and/or function, of the projection device 12, and/or applications to run the projection system 10.

Memory 24 may include volatile memory and/or non-volatile memory. Non-volatile memory may be utilized to store permanent or semi-permanent data. Such non-volatile memory may be any suitable type of non-volatile memory, including, but not limited to, ROM, PROM, EPROM, EEPROM and Flash memory, and combinations thereof. Volatile memory may be utilized to store temporary data, including images and instructions. Volatile memory may include one or more suitable types of volatile memory, such as SRAM or DRAM.

The example shown in FIG. 1 illustrates a laptop computer as a content source 14. In other examples, other content sources may be used. Including, but not limited to other personal computers, such as desktop computers, storage mediums, such as memory cards and other memory devices, DVDs, cameras, telephones, Smartphones, portable data assistants, etc.

Typically, the image display device may include a body or housing. Contained within the housing may be a light source and an image-generation device. The light source may be adapted to produce a beam of light and project the light towards the image-generation device, which may be configured to generate and project an image.

In some embodiments, the light source may include a lamp positioned within a reflector that may be configured to direct most of the emitted light along an optical path of the system. The light source may include any suitable type of lamp. Examples include, but are not limited to, metal halide lamps and ultra-high-pressure (UHP) arc lamps, lasers, light emitting diodes (LED), organic light emitting diodes, etc. The system also may include one or more filters, such as an infrared (IR), or ultraviolet (UV) filter, to filter out unwanted parts of the emission spectra of the lamp.

The image-generation device may be configured to receive the light from the light source, and to generate an image to be projected. The image-generation device may include an optical engine, image-producing element, filters, color wheels, lenses, mirrors, integrators, condensers, and other suitable optical elements. Such elements may be configured to generate an image. For example, the image generation device may include an image-producing element, such as, but not limited to, a digital micromirror (DMD), an LCD panel, or any other suitable image source. In some embodiments, the image-producing element may be configured to project light toward one or more lenses, mirrors or other optics, which, in turn, may be configured to project light toward the display surface.

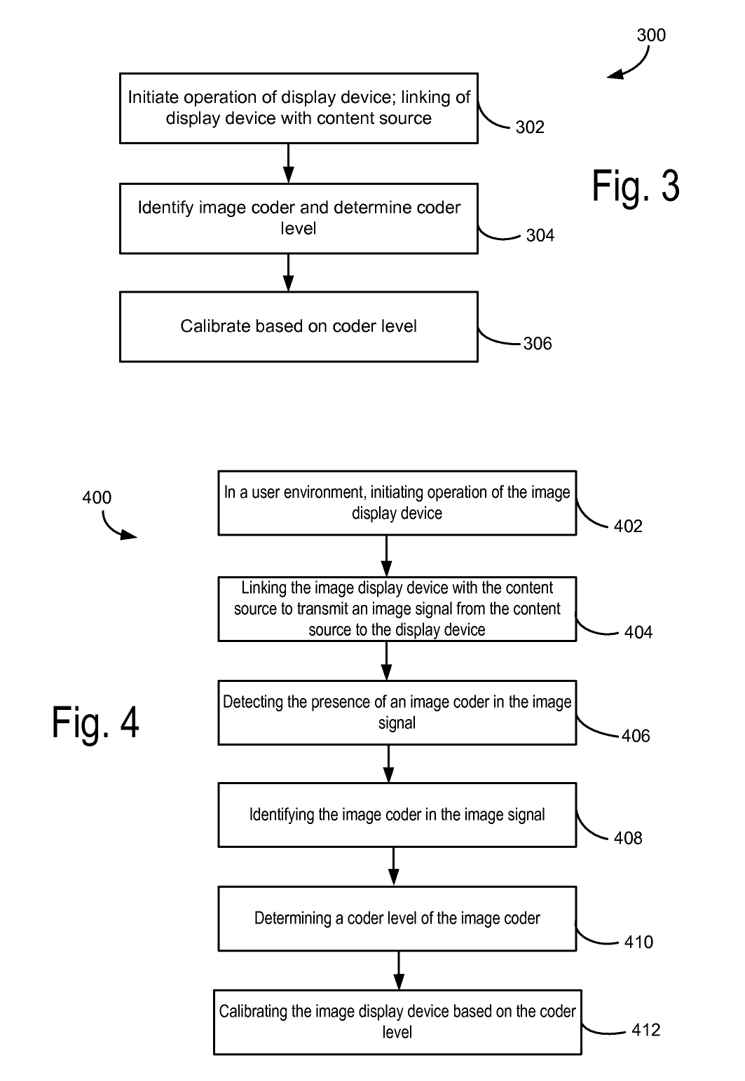

FIG. 2 is a schematic diagram illustrating an example image display device 12 in accordance with the present disclosure. The display device 12 may have a memory 24, and a processor 22 operatively coupled with the memory 24. The memory 22 may include stored processor-executable instructions which, when executed by the processor 22, may perform various steps for generating accurate images for display based on a particular image, or content source 14.

One example image display device 12 may generate accurate black levels when coupled with a particular content source 14. Another example may ensure a proper color gamut is used when displaying images from a particular content source 14. Examples may be configured with various content sources, and may automatically, or substantially automatically, generate accurate images from each of the various content sources.

The memory 22 may include a logic module 230. In determining accurate black levels, the logic module 230 may include an image signal analysis module 232 that may include an inference engine 234, or other logic that may be configured to derive answers from a knowledge base. The inference engine 234 may include a data store 236 that may hold various facts or assertions about a particular problem relevant to the operation of the image display device 12, and a set of rules 238 which constitute the program. The inference engine 234 may execute the rules 238 by determining which rules are relevant to the data store 236. For example, the inference engine 234 may detect the presence of one or more coders included in an image signal 240 from the image source 14. In some examples the inference engine 238 may use image levels in the image signal and uniformity of the image signal, as input to the inference engine 234, to detect the presence of the one or more image coders 20 such as the black bars shown in FIG. 1. In other examples, logic other than inference logic may be used. As discussed more herein below, based on the one or more coders, a black level setting may be adjusted by a settings module 272 coupled with the image analysis module 232.

In some examples, the memory 24 may include stored processor-executable instructions which, when executed by the processor 22 may perform steps for selecting a color gamut for use by the image display device 12. In these examples, the logic module 230 may include a signal recognition module 250 that may include a signal type store 252 that may hold various signal types that may be used to compare with, and identify, the image signal 240 from the image source 14. The steps, executable by the processor 22, may include for example, receiving an image signal 240 from the content source 14. The steps may also include identifying an image signal type of the image signal 240 from among a predetermined set of recognizable image signals. The recognizable image signals may be stored in the signal type store 252. In addition, based on the image signal type identified, the steps may include selecting the color gamut from a store of color gamuts 256 for the image display device 12 to use to display images from the content source 14. Once the image signal 240 is recognized by the signal recognition module 250, as a particular signal type, a particular color gamut corresponding with the particular signal type may be sent from the store of color gamuts 256 to a display module 270. The display module 270 may include some, or all, of the components discussed earlier, such as the image-generation device. In some examples the particular color gamut may be sent to the display module 270 via the settings module 272.

In some examples, the display device 12 may also be configured or adapted to recognize a user selectable input or setting requesting an automatic selection of the color gamut based on the image signal 240. The user selectable input may be provided via an interface 260 coupled with the logic module 230 via an I/O module 262.

In some examples, the processor-executable instructions may perform steps that may further comprise operatively coupling the display device with a data source 274. In some examples, the data source may be resident on the display device 12. In other examples, the display device may be operatively coupled to the data source 274 via a network connection such as an internet connection 276, as illustrated schematically as a cloud in FIG. 2. The steps performed may include updating the set of recognizable image signals by adding at least one additional image signal type from the data source 274 as an additional recognizable image signal. The steps performed may also include updating the store of color gamuts 256 by adding at least one additional color gamut to the store of color gamuts 256. The least one additional color gamut may correspond with the at least one additional image signal type. The at least one additional gamut may be configured to be used by the display device 12 to display images from an additional content source.

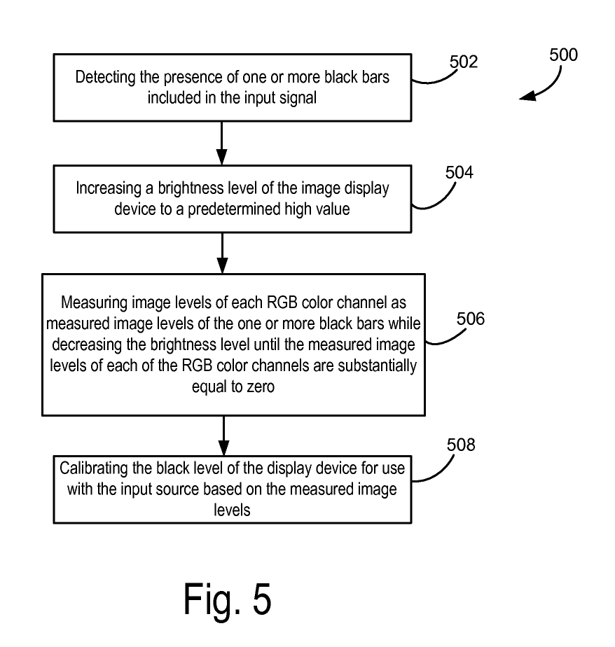

FIG. 3 is a flow chart illustrating an example method 300 for calibrating the image display device to the content source in accordance with the present disclosure. The method 300 may include, at 302, initiation of operation and projection of an image. This step may include linking the display device to a content source where the content source may provide an image. The image from the content source may include coders. These coders may be integrated into a first opening display device image or may be integrated within a specific image provided by the content source. In some embodiments, the coders may be disposed in the corners of the image, in other embodiments, the coders may be in the center or center region of the image. Multiple coders may be used such that information from the coders can be compared to interpret the image as provided from the content source.

Referring still to FIG. 3, the display device may be configured, at 304, to determine a coder level. For example, the light level of the coders may be compared to determine if the coders are a uniform level and the discrepancies between the coders across the image. Further, the display device may determine whether the coders are visible. The coders color levels may be compared to the content image source such that differences between the image as provided by the content source and the coders are identified. At 306, the display device may be calibrated based on the coders levels to enable the displayed image to more directly replicate the content source image.

In one example, incorrect black levels may lead to decreased image detail and/or lower contrast. However, trying to manually set the black level is difficult without the proper test setup. Analog video sources typically require calibration due to variation in the output signal levels. This calibration typically requires test patterns and/or calibration devices such as light meters. In the present disclosure, one implementation of the coders is for automatic black level calibration control based on the optimal black level for the current image source.

In one example, the coders may be black bars either on the top or bottom of the image. In other embodiments, the coders may be on the left or rights side of the image. The shape and size of the coders may enable additional interpretation to calibrate the display system to the content source.

In some embodiments, the user may input a request for the calibration to the content source, such as a button to enable black level calibration. In other embodiments, the content source calibration, such as black level calibration, may automatically occur during startup or upon change in the content source.

When the feature is initiated, an initial estimation may be made of the image levels and the uniformity on whether the required coders, such as the black bars, are present. If so, the brightness is first set to an intentionally high value and then decreased until the image level on the RGB channels (i.e. Red, Green, Blue channels) are all measured to be zero or substantially zero. In other embodiments, instead of decreasing brightness, the offsets of each channel (RGB) may be separately adjusted. Separated adjustment may enable additional controls.

As described, the coders may be integrated into an image to enable automatic black level calibration. In other embodiments, the coders may be provided with additional color information which may be adjusted to enable matching of the optimal color levels for the content source.

FIG. 4 is a flow chart illustrating another example method 400 for calibrating the image display device to the content source in accordance with the present disclosure. The method 400 may include, at 402, in a user environment, initiating operation of the image display device. The method 400 may also include, at 404, linking the image display device with the content source to transmit an image signal from the content source to the display device. The method 400 may also include, at 406, detecting the presence of an image coder in the image signal. The method 400 may also include, at 408, identifying the image coder in the image signal. The method 400 may also include, at 410, determining a coder level of the image coder. In addition, the method 400 may include, at 412, calibrating the image display device based on the coder level.

A user environment may be defined as an environment distinct from a factory, or manufacturing environment. The user environment may be, for example, a home, an office, or a school, or the like. An end user may be defined as a user of the device after the device has been purchased.

As mentioned, in some examples, the image coder is one or more black bars. In some examples, the one or more black bars may be located in a displayed image at one or more of a top of the displayed image, a bottom of the displayed image, a right side of the displayed image, and a left side of the displayed image. In other examples the one or more black bars may be in the center or center region of the image.

In some examples, the image coder may be a black area. Further, the display device may have RGB channels. The RGB channels may have adjustable image levels, and the determining a coder level of the image coder may include increasing a brightness value of the display device to a predetermined high brightness level, and then decreasing the brightness value until the image level of all the RGB channels are measured to be equal to, or substantially equal to zero, in the black area.

In another example, the image coder may also be a black area, and the display device may also have RGB channels with adjustable image levels. However, in this case, the determining a coder level of the image coder may include separately adjusting an offset of each RGB channel.

In some examples, the detecting the presence of the image coder may include using an inference engine. The inference engine may use image levels in the image signal and uniformity of the image signal for the detecting.

In some examples, the initiating operation of the image display device may be performed by an end user of the display device. In such cases the detecting, the identifying, the determining, and the calibrating may be performed by at least one tangible computer-readable storage medium having stored computer-executable instructions. The storage medium may be resident in the display device. In other examples the initiating may also be performed by executing the computer-executable instructions.

FIG. 5 is a flow chart illustrating another example method 500 for calibrating a black level of an image display device in accordance with an image signal from an image source when the image source is coupled with the display device in a user environment. The method 500 may include, at 502, detecting the presence of one or more black bars included in the image signal. The method 500 may also include, at 504, increasing a brightness level of the image display device to a predetermined high value. The method 500 may also include, at 506, measuring image levels of each RGB color channel, as measured image levels of the one or more black bars, while decreasing the brightness level until the measured image levels of each of the RGB color channels are substantially equal to zero. In addition, the method 500 may also include, at 508, calibrating the black level of the display device for use with the image source based on the measured image levels.

In some examples, the detecting the presence of one or more black bars included in the image signal may be accomplished, at least partially, using an inference engine. The inference engine may use image levels in the image signal, and uniformity of the image signal to detect the presence of the one or more coders.

In some examples, a processor may be resident in the image display device. The inference engine may include processor executable instructions residing in a memory resident in the image display device. The inference engine may be configured to perform the detecting the presence of one or more black bars included in the image signal for a plurality of various image sources in the user environment.

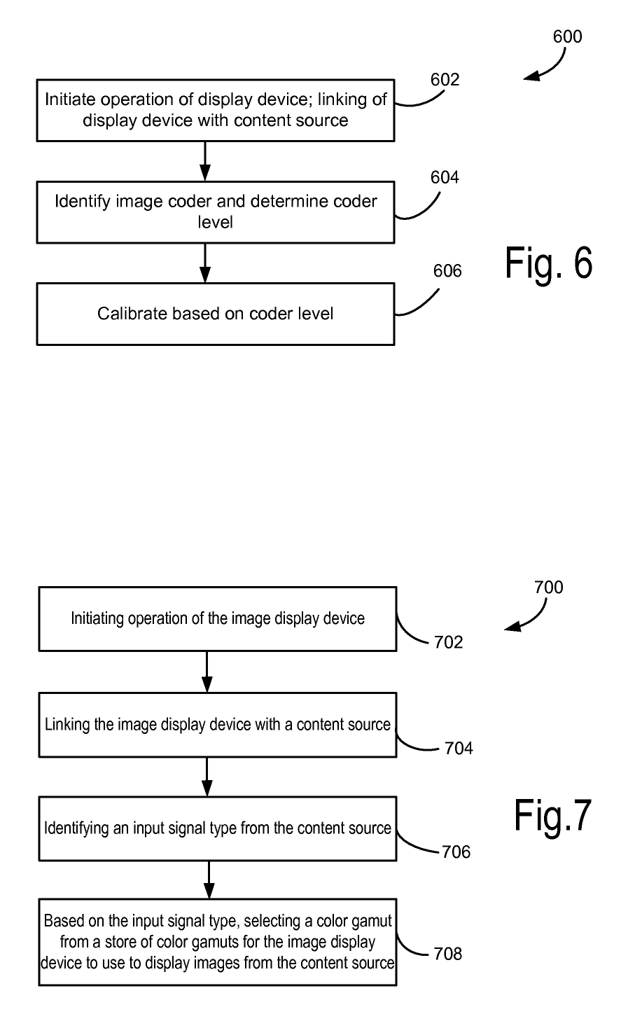

FIG. 6 is a flow chart illustrating another example method 600 in accordance with the present disclosure. The method 600 may be used for selecting a color gamut for the image display device. Typically, for accurate color reproduction, the color gamut of the display device may need to match the color gamut of the recorded content. Prior systems where a user used a maximum color gamut that the display can provide resulted in no primary color correction. Example embodiments in accordance with the present disclosure may provide systems and methods to automatically identifying color content information from the content source to enable the projected image to more directly replicate the image colors as provided by the content source.

The example method 600 illustrated may include, at 602, initiation of operation and projection of an image. This step may include linking the display device to a content source where the content source may provide an image. The content source may provide content through an image signal. As shown, at 604, the display device may be configured to identify the image signal type. Depending on the image signal type, the method 600 may continue, at 606 to automatically select a color gamut based on the identified signal type.

FIG. 7 is a flow chart illustrating another example method 700 of selecting a color gamut for use with an image display device. The method 700 may include, at 702, initiating operation of the image display device. The method 700 may include, at 704, linking the image display device with a content source. The method 700 may continue, at 706, by identifying an image signal type from the content source. In addition, the method 700 may include, at 708, based on the image signal type, selecting a color gamut from a store of color gamuts for the image display device to use to display images from the content source. The image signal type is considered as another image coder.

In some examples of method 700, the linking 704, the identifying 706, and the selecting 708 may be performed in a user environment. In addition the method 700 may be performed for various content sources.

In some examples, the identifying an image signal type from the content source 706 may include comparing the signal from the content source to a store of known content sources. The store of color gamuts may resident on the display device, for example, in a memory such as memory 24 shown in FIG. 2. In other cases, the store of color gamuts may resident somewhere else.

The store of color gamuts may include one or more gamuts that may for example be recommended by, recognized by, and/or endorsed by one or more display industry organizations. The display industry organizations may be selected from the group consisting of SMPTE, EBU, ITU-R. Gamuts from other organization may also be included in the store of color gamuts.

In addition, or alternatively, the one or more gamuts may recognized as being usable with one or more industry display systems, and/or modes, selected from the group consisting of: NTSC, PAL, SECAM, 480i, 480p, 576i, 576p, 720p, 1080i, 1080p. Gamuts usable with other systems, and/or modes, may also be included.

Inventions embodied in various combinations and sub-combinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A method for calibrating an image display device to a content source, the method comprising:
in a user environment, initiating operation of the image display device;
linking the image display device with the content source to transmit an image signal from the content source to the display device;
detecting the presence of an image coder in the image signal;
identifying the image coder in the image signal;
determining a coder level of the image coder; and
calibrating the image display device based on the coder level.

2. The method of claim 1, wherein the image coder is a black level coder.

3. The method of claim 2, wherein calibrating the image display devices includes black level calibration.

4. The method of claim 1, wherein the image coder is a black area, and the display device has RGB channels with adjustable image levels, and wherein the determining a coder level of the image coder includes increasing a brightness value of the display device to a predetermined high brightness level, and then decreasing the brightness value until the image level of all the RGB channels are measured to be equal to, or substantially equal to zero, in the black area.

5. The method of claim 1, wherein the image coder is a black area, and the display device has RGB channels with adjustable image levels, and the determining a coder level of the image coder includes separately adjusting an offset of each RGB channel.

6. The method of claim 1, wherein the detecting the presence of the image coder includes using an inference engine, the inference engine using image levels in the image signal and uniformity of the image signal.

7. The method of claim 1, wherein the initiating operation of the image display device is performed by an end user of the display device, and the detecting, the identifying, the determining, and the calibrating are performed by at least one tangible computer-readable storage medium having stored computer-executable instructions, the storage medium being resident in the display device.

8. The method of claim 1, wherein at least the detecting, the identifying, the determining, and the calibrating, are performed by at least one tangible computer-readable storage medium having stored computer-executable instructions, the storage medium being resident in the display device.

9. A method for calibrating a black level of an image display device in accordance with an image signal from an image source when the image source is coupled with the display device in a user environment, the method comprising:
detecting the presence of one or more black bars included in the image signal;
increasing a brightness level of the image display device to a predetermined high value;
measuring image levels of each RGB color channel as measured image levels of the one or more black bars while decreasing the brightness level until the measured image levels of each of the RGB color channels are substantially equal to zero; and
calibrating the black level of the display device for use with the image source based on the measured image levels.

10. The method of claim 9, wherein the detecting the presence of one or more black bars included in the image signal is accomplished, at least partially, using an inference engine.

11. The method of claim 10, wherein the inference engine uses image levels in the image signal and uniformity of the image signal to detect the presence of the one or more coders.

12. The method of claim 9, further comprising automatically calibrating the black level.

13. The method of selecting a color gamut for use with an image display device, the method comprising:
initiating operation of the image display device;
linking the image display device with a content source;
identifying an image signal type from the content source; and
based on the image signal type, selecting a color gamut from a store of color gamuts for the image display device to use to display images from the content source.

14. The method of claim 13, wherein identifying an image signal type from the content source includes comparing the signal from the content source to a store of known content sources.

15. The method of claim 13, wherein the store of color gamuts is resident on the display device.

16. The method of claim 13, wherein the store of color gamuts includes one or more gamuts that are:
recommended by, recognized by, and/or endorsed by one or more display industry organizations selected from the group consisting of SMPTE, EBU, ITU-R; and/or
recognized as being usable with one or more industry display systems, and/or modes, selected from the group consisting of: NTSC, PAL, SECAM, 480i, 480p, 576i, 576p, 720p, 1080i, 1080p.

17. A display device having a memory and a processor operatively coupled with the memory, the memory including stored processor-executable instructions which, when executed by the processor, perform steps for calibrating the image display device, the steps comprising:
receiving an image signal from a content source, where the image signal includes an image coder;
identifying the image coder; and
based on the image coder, calibrating the image display device to adjust the display of the image.

18. The display device of claim 17, wherein the image coder is dependent on the content source and is selectable from among a predetermined set of recognizable image signals.

19. The display device of claim 18, wherein calibrating the image display device includes selecting the color gamut from a store of color gamuts in the memory for the image display device to use to display images from the content source.

20. The display device of claim 19, further comprising
updating the set of recognizable image signals by adding at least one additional image signal type from the data source as an additional recognizable image signal; and
updating the store of color gamuts by adding at least one additional color gamut to the store of color gamuts, the least one additional color gamut corresponding with the at least one additional image signal type, and the at least one additional gamut configured to be used by the display device to display images from an additional content source.

21. The display device of claim 17, where the image coder is a black level coder and calibrating includes black level calibration.
